(19) United States
(12) Patent Application Publication
(10) Pub. No.: US 2005/0264804 A1
(43) Pub. Date: Dec. 1, 2005

(54) Bi-modal control material for particle size analyzers

(75) Inventors: Gary L. Slater, Rochester, NY (US); Edwin J. Voll, Rochester, NY (US); Lisa A. Slater, Rochester, NY (US); Ben C. Wood, Marion, NY (US); Thomas E. Ouimet, Rochester, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 10/855,199

(22) Filed: May 27, 2004

(51) Int. Cl. G01N 21/00

(52) U.S. Cl. 356/243.2

(57) ABSTRACT

A control material for monitoring performance of a particle size analyzer has a population of small particles on the order of 1 μm and a population of larger particles on the order of 15 μm suspended in deionized water containing a surfactant and a biocide. Performance is monitored by delivering an ampoule of check material to the analyzer and detecting the ratio of particle size peaks.

### FIELD OF THE INVENTION

This invention relates to an apparatus and method for monitoring performance of a light scattering particle size analyzer using a control material. This control material is a dispersion of different sized particles contained in a sealed ampoule to be used to monitor the performance of light scattering particle size analyzers.

### BACKGROUND OF THE INVENTION

Particle size analyzers are scientific instruments used to measure the size and quantity of various sized particles suspended in a fluid. There are many different types of particle size analyzers to measure different size ranges of particles in different fluids with varying degrees of precision and resolution. All of these particle size analyzers have a common need; that is the ability to monitor the analyzer performance by using a stable model particulate system that is well understood. This monitoring of these particle size analyzers is useful in calculating statistical quality control charts, which are then used to diagnose the status of the analyzers. It is critical to understand the status or behavior of these particle size analyzers so as to be able to distinguish whether a certain measurement by the analyzer is valid and that this measurement is due to the sample particle size distribution rather than a false artifact of the analyzer performance.

Artifacts due to the analyzer itself can arise from many causes. An artifact could be due to a malfunction of the light source in the detection system. This light source may suddenly cease to emit light altogether or may drift up or down in emitted intensity. There may be a variety of light sources or filter systems to provide various wavelengths of light used in the analyzer. These various light sources or filter systems may malfunction, thus causing an analyzer artifact. Yet another source of an analyzer artifact could be due to a malfunction of the scattered light detector. The light detector may become unstable due to changes in ambient conditions and cause unwanted electronic noise in the analyzer. Another source of an analyzer artifact is misalignment or contamination of the optical systems such as lenses, mirrors, or sample cells. This misalignment or contamination of the optical system can cause spurious signals, which are misinterpreted as real data from the actual sample. Still another source of an analyzer artifact could arise from malfunction of the electronic amplification and signal processing systems. Thus the raw scattered light could be magnified or minimized in such a way that the corresponding final particle size distribution is skewed or shifted to an incorrect distribution. Finally, the mathematical algorithms used to convert the scattered light intensity to a final particle size distribution format may be corrupt or have the incorrect input parameters necessary to produce a correct particle size distribution.

It is well known in the art that dispersed particles, either naturally occurring or man-made can be used to calibrate and check the performance of particle size analyzers. For example, U.S. Pat. No. 5,373,182 describes the use of fluorescent polymer microbeads to calibrate a flow cytometer. In another example, U.S. patent Document 20030092184 describes a quality control method for diagnosing the performance of hematology instruments. In another example U.S. Pat. No. 6,542,833 describes a method of checking the performance of a flow cytometer instrument. The particles used in these patent documents as the check material do not, in a single application of the analyzer check process, cover the potential full dynamic range of sensitivity of the analyzer. That is, the full range of sensitivity of particle size analyzers requires a mixture of more than one check material to be analyzed at the same time. Another problem is that the amount of the check material added to the analyzer is by nature variable, usually being controlled by an operator adding a drop or some other small volume of said control material to the analyzer. This variability in the amount of check particles added to the analyzer can cause variability in the expected response of the analyzer due to unacceptably low or high particle concentration in the analyzer. These uncontrolled concentrations may cause artifacts of their own such as low signal to noise ratio for too few particles or coincidence errors for too many particles.

Thus, there exists a need for a check sample material that permits simultaneously evaluating the entire sensitivity of a light scattering instrument along with each detector system.

### SUMMARY OF THE INVENTION

The present invention is directed to overcoming one or more of the problems set forth above. Briefly summarized, according to one aspect of the present invention, a control material for monitoring performance of a particle size analyzer comprises a population of first particles with each particle of the population of first particles having a first mean particle size, a population of second particles with each particle of the population of second particles having a mean particle size, and a volume of liquid with the first and second populations of particles suspended in the liquid. Deviation from the mean particle size in the populations of first particles is greater than 1.2 times a defined geometric standard deviation.

The control material is preferably spherical polymer beads with a surfactant and a biocide. Controlled volumes of the bi-modal control material is packaged in an ampoule.

According to another aspect of the invention, a method for monitoring performance of a particle size analyzer comprises delivering a check material to the analyzer and detecting the ratio of particle size peaks. The check material has a population of first particles and a population of second particles suspended in a liquid. Preferably, the first particles have a mean size of about 1 μm and the second particles having a mean size of about 15 μm. The method may include defining a reference peak, comparing measured amounts of particles to the reference peak, and diagnosing failings of subsystems of the analyzer.

According to another aspect of the invention, a method for monitoring performance of a particle size analyzer comprises agitating an ampoule containing a check sample, breaking open the ampoule, delivering the check sample to the analyzer, and detecting the ratio of particle size peaks. The check sample has a population of first particles and a population of second particles suspended in a liquid with the first particles having a mean size of about 1 μm and the second particles having a mean size of about 15 μm. The method may include defining a reference peak and comparing measured amounts of particles to the reference peak. Using the method with the bimodal control material facilitates diagnosing failings of subsystems of the analyzer.

### BRIEF DESCRIPTION OF THE DRAWINGS

The above and other objects, features, and advantages of the present invention will become more apparent when taken in conjunction with the following description and drawings wherein identical reference numerals have been used, where possible, to designate identical features that are common to the figures, and wherein:

FIG. 1 is a graph showing particle size distribution of the two component polymer beads with an analysis of the bi-modal mixture;

FIG. 2 is a glass ampoule containing a measured amount of the bi-modal mixture;

FIG. 3 is a graph illustrating various parameters of the two distinct particle populations;

FIG. 4 is a graph illustrating a bi-modal material with a failing lower wavelength source; and

FIG. 5 is a graph illustrating bi-modal material with an unadjusted laser light source.

### DETAILED DESCRIPTION OF THE INVENTION

In order to meet the aforementioned advantages, the inventors have discovered that to monitor the overall performance of the full dynamic range of a particle size analyzer, the dispersed particles used as a check material must contain at least two distinct particle size populations. In particular, the median, volume weighted size of the smaller population should be about 1 μm while the median volume weighted size of the larger particle should be about 15 μm. In a preferred embodiment, the breadth of each the individual particle populations is greater than 1.2 geometric standard deviation as defined in Particle Size Measurement, T. Allen, fourth edition, Chapman and Hall, 1990. This breadth of the distinct distributions allows for a more realistic check material, similar to what may be expected in real experience. In addition, the breadth of the distributions allow for monitoring of more of the dynamic range of the analyzer than if a very narrow distribution with a geometric standard deviation closer to 1.0 was used.

The bi-modal check material is a mixture of two polymer bead populations dispersed in water with a small amount of surfactant and biocide to preserve and disperse the beads. The mixture can best be made in a large vessel having a capacity of 50-100 gallons by adding the solid check particles to the vessel as seen in table 1.

TABLE 1

| | |
|---|---|
| Add solids | 16 g of styrene divinylbenzene crosslinked beads. |
| | 9 g of butyl acrylate, trimethylolpropane triacrylate, |
| | methyl methacrylate crosslinked beads. |
| Add 0.5% of a | 260 g of 1% SDS |
| 1% SDS solution | |
| Stir gently to wet | |
| the solids | |
| Add DI H₂O | 52000 g (52 Kg) |
| Stir Mixture | |
| for 30 min. | |
| Analyze 20 g of | |
| mixture to | |
| ensure Bi-modal | |
| composition is what | |
| is expected | |

The solid check material particles are preferably beads made of polystyrene, divinylbenzene, polymethymethacrylate, or co-polymers of these or other monomers. A mixture of approximately 95% polystyrene and 5% di-vinylbenzene copolymer beads in an amount of 16 grams is added to the vessel along with 9 grams of butyl acrylate, trimethylolpropane triacrylate, methyl methacrylate co-polymer beads. After the particles are added to the vessel, a surfactant, such as sodium dodecyl sulfate, SDS, is added to help stabilize and disperse the particles. Preferably, 260 grams of (0.5%) of a 1% SDS solution is added. Gentle stirring wets the particles. Next, 52 kg of deionized water is added to the mixing vessel. The mixture is then stirred for 30 minutes. After stirring, a 20 gram sample of the mixture is taken for analysis to ensure the bi-modal composition is as expected.

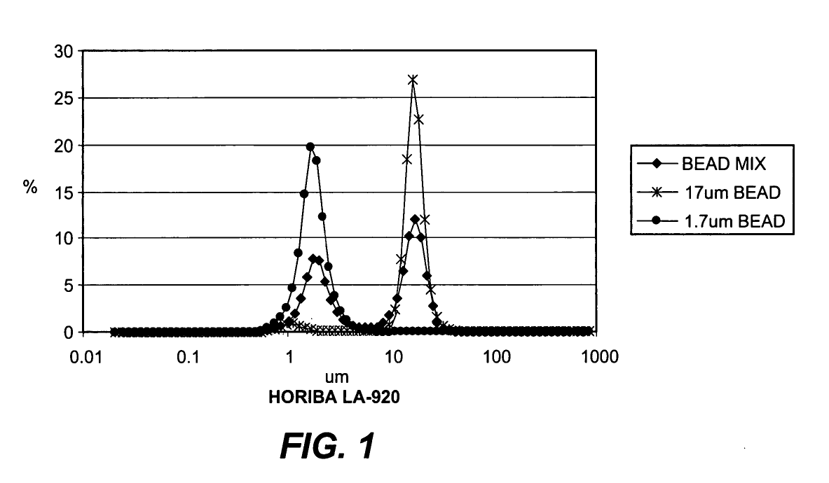

FIG. 1 shows the particle size distributions of the two component polymer beads along with an analysis of the bimodal mixture. The bead mixture exhibits two peaks with an 8% peak at about 1.7 μm particle size and a 12% peak at about 17 μm particle size. The smaller particles have a peak concentration of about 20% at 1.7 μm particle size, and the larger particles have a peak concentration of about 27% at 17 μm particle size.

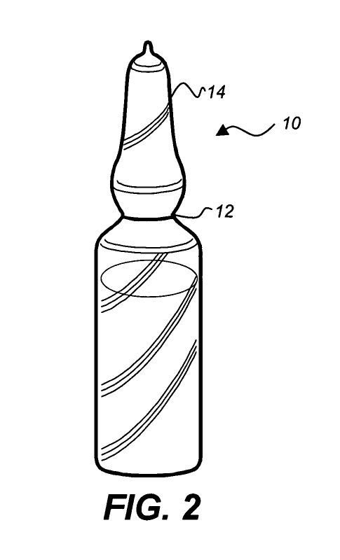

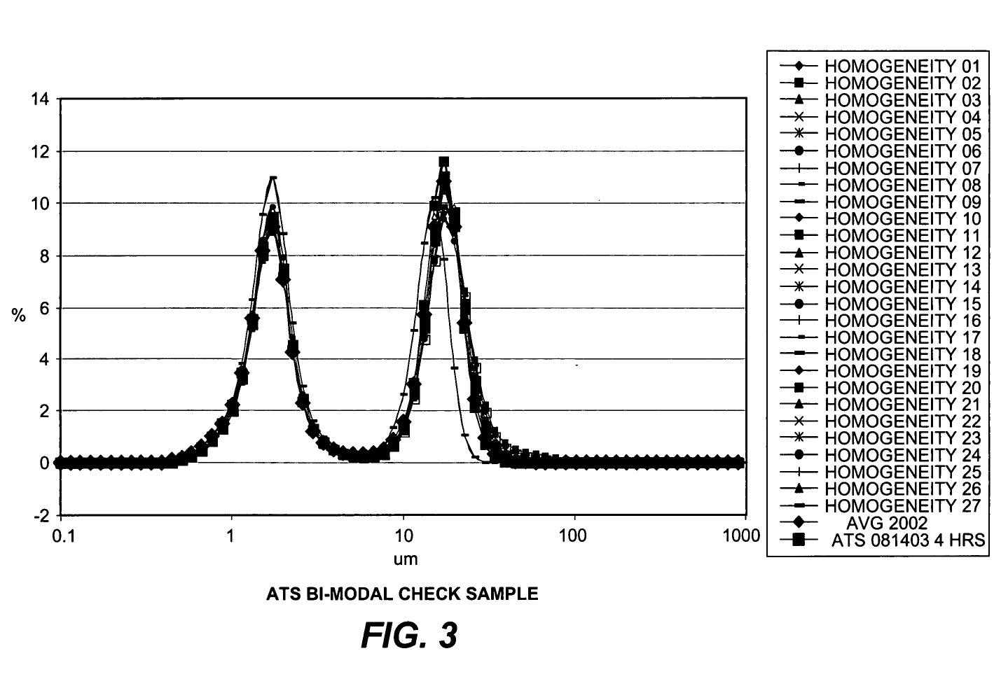

Referring to FIG. 2, a glass ampoule 10 is filled with the bi-modal mixture. While being stirred to preserve homogeneity, small volumes of the mixture are drawn off into a glass ampoule. The neck 12 of the glass ampoule is quickly heated and fused closed. In a preferred embodiment, the glass ampoule volume is 20 ml total of which the bimodal check material occupies about 15 ml. The neck of the ampoule is made in such a manner as to be easily snapped to remove the head 14 and thus provide an opening for the check material to be entirely dispensed into the analyzer to be monitored. The ability to dispense the same volume of fluid per analysis every time allows a high degree of precision of measuring the various parameters of the two distinct particle populations including, but not restricted to, the mode, mean, median, breadth, area under the curve shown in FIG. 3.

The following examples are provided to illustrate the invention.

### EXAMPLE 1

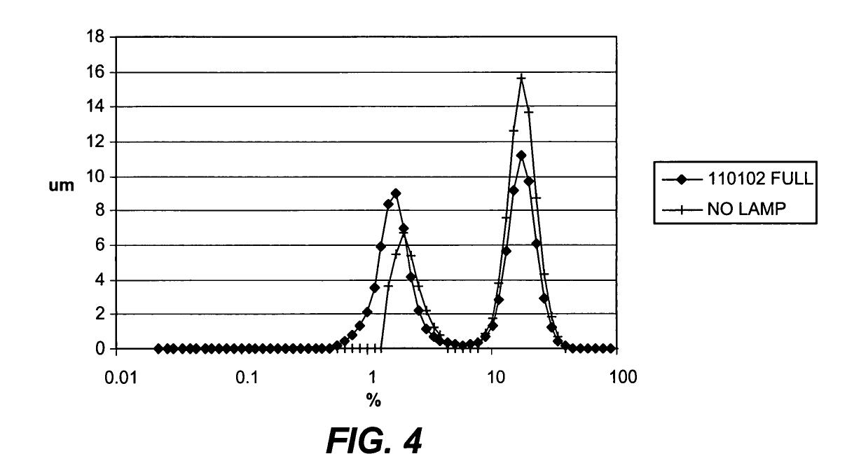

Example 1 is a measurement of bimodal check material with failing lower wavelength source. Particle sizes were measured using a Horiba LA-920 light scattering particle size analyzer manufactured by Horiba Instruments; U.S.A. Particle to water relative refractive index was 1.20 with 10% imaginary component. This example, shown in FIG. 4 shows the advantage of having a bimodal check material to monitor the performance of a particle size analyzer. The curve labeled “110102” full is a normal distribution for the bimodal check material. The curve labeled “no lamp” was obtained as the lower wavelength light source on the analyzer was losing intensity. The smaller population mode of this curve can clearly be seen to be truncated well above 1 μm, thus giving warning to the operator that something related to the small size detection capabilities of the analyzer is deficient. In fact, since the two light sources in this case use the same optics, it is possible to trace the problem to the weakening low wavelength light source.

### EXAMPLE 2

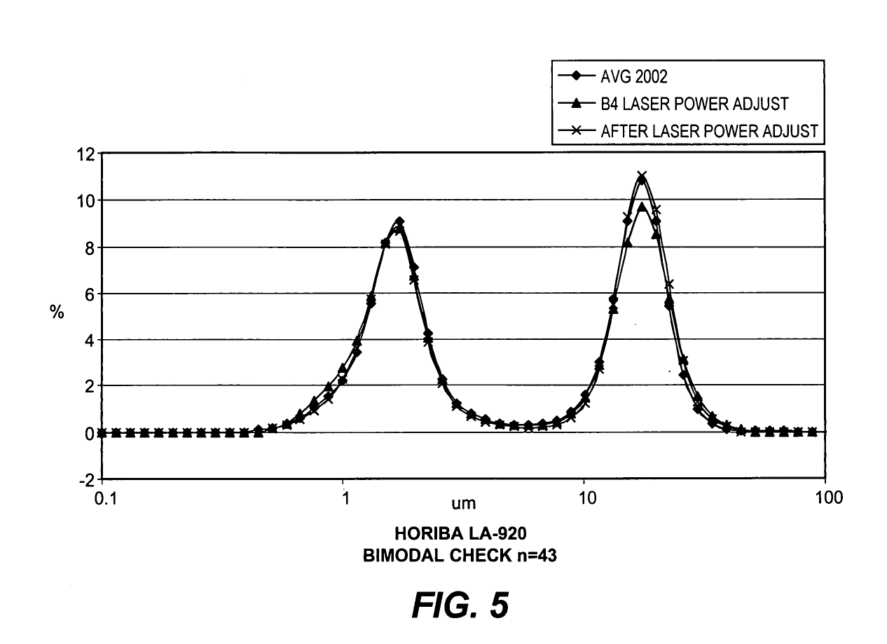

Example 2 is a measurement of bimodal check material with unadjusted laser light source. The analyzer was used as in Example 1 to measure the bimodal check sample. In this case, however, the overall mean of the bimodal check material was out of statistical control. In order to determine possible causes for this shift, a current analysis of the check material was compared with an average of many runs made during a previous time period denoted as Avg 2002, as shown in FIG. 5. The curve labeled “B4 Laser Power Adjust” was from a recent analysis. By observing that the “B4 Laser Power Adjust” mode was lower at the large end of the distribution, one could see that the laser power was slightly off. When the laser power source was checked and a readjustment made the “After Laser Power Adjust” curve was obtained which showed that the analyzer was back into control.

1. A control material for monitoring performance of a particle size analyzer, comprising:
a population of first particles, each particle of said population of first particles having a first mean particle size;
a population of second particles, each particle of said population of second particles having a second mean particle size; and
a volume of liquid, said first and second populations of particles being suspended in said liquid.

2. The control material set forth in claim 1 wherein said first mean particle size is about 1 μm.

3. The control material set forth in claim 1 wherein said first mean particle size is about 15 μm.

4. The control material set forth in claim 1 including a surfactant.

5. The control material set forth in claim 1 including a biocide.

6. The control material set forth in claim 1 wherein deviation from the mean particle size in said population of first particles is greater than 1.2 times a defined geometric standard deviation.

7. The control material set forth in claim 1 wherein deviation from the mean particle size in said population of first particles is greater than 1.2 times a defined geometric standard deviation.

8. The control material set forth in claim 1 wherein each of said first and second particles is spherical.

9. The control material set forth in claim 1 wherein each of said first and second particles is a polymeric bead.

10. The control material set forth in claim 1 including an ampoule for housing single check sample.

11. A method for monitoring performance of a particle size analyzer, comprising the steps of:
delivering a check material to the analyzer, said check material having a population of first particles and a population of second particles suspended in a liquid, said first particles having a mean size of about 1 μm and said second particles having a mean size of about 15 μm; and
detecting the ratio of particle size peaks.

12. The method of claim 9 including:
defining a reference peak;
comparing measured amounts of particles to the reference peak; and
diagnosing failings of subsystems of the analyzer.

13. A method for monitoring performance of a particle size analyzer, comprising the steps of:
agitating an ampoule containing a check sample, said check sample having a population of first particles and a population of second particles suspended in a liquid, said first particles having a mean size of about 1 μm and said second particles having a mean size of about 15 μm;
breaking open the ampoule;
delivering the check sample to the analyzer; and
detecting the ratio of particle size peaks.

14. The method of claim 13 including defining a reference peak, and
comparing measured amounts of particles to the reference peak.

15. The method of claim 13 including diagnosing failings of subsystems of the analyzer.
